(19) United States
(12) Patent Application Publication
(10) Pub. No.: US 2019/0079880 A1
(43) Pub. Date: Mar. 14, 2019

(54) AUTOMATICALLY CONFIGURING THE SETTINGS OF PERIPHERAL DEVICES

(71) Applicant: Datamax-O'Neil Corporation, Orlando, FL (US)

(72) Inventors: Erik Karl Henning Unemyr, Singapore (SG); Thomas Axel Jonas Celinder, Singapore (SG)

(21) Appl. No.: 15/700,722

(22) Filed: Sep. 11, 2017

(51) Int. Cl. G06F 13/10; G06F 1/26

(52) U.S. Cl. CPC G06F 13/102; G06F 2213/0042; G06F 1/266

(57) ABSTRACT

Systems and methods for configuring the settings of a peripheral device are provided. In one implementation, a method includes a step of determining when the peripheral device is powered up and in communication with a host device. The method further includes the step of reading configuration settings associated with an operating system of the host device when the peripheral device is determined to be powered up and in communication with the host device. Also, the method includes communicating the configuration settings associated with the operating system of the host device to the peripheral device for configuring the settings of the peripheral device.

### FIELD OF THE INVENTION

The present invention relates to peripheral devices, such as printers, and for configuring the settings of the peripheral devices.

### BACKGROUND

Printers and other peripheral devices are often connected to computers for performing specific functions. When an out-of-box peripheral device is first connected to a computer, the user is typically required to configure the settings of the peripheral device before it can be used. The configuration settings may include, for example, the geographic region in which the computer system is operating and the network environment of the computer system. The configuration settings may also include the user's preferences. These categories of settings may include a language setting, a time setting, a date settings, a time zone setting, units of measure settings for various variables that may be displayed on the peripheral device, and other settings.

For instance, during use, the peripheral device may display certain information on a screen of the peripheral device to show status information, to show time and date information, to prompt the user for action, or for other reasons. Thus, in order for the peripheral device to properly display information that is relevant to the particular network environment, geographic region, and user preferences of the system in which the computer and peripheral device operates, the configuration settings of the peripheral device must be entered before use.

The end user therefore must not only set up the peripheral device and connect the device to the host device or computer, but the end user must also enter several choices to match the geographical region, network environment, units of measure, preferences, etc. Thus, multiple manual steps are required for configuring all the various settings, which adds complexity and time to the setup process. Therefore, a need exists for simplifying the peripheral device setup process required by the user and for enabling automatic configuring and/or reconfiguring processes with little or no effort on the part of the user.

### SUMMARY

Accordingly, in one aspect, the present invention embraces systems, devices, and methods for automatically configuring the settings of a peripheral device, such as a printer or label printer. When the peripheral device is placed in communication with a host device or computer, either by wired connection or wireless transmission means, the embodiments of the present disclosure provide the automatic configuring of the settings based on relevant information stored in the host device itself.

In an exemplary embodiment, a system for configuring the settings of a peripheral device is provided. The system in this embodiment includes a host device that has memory for storing at least an operating system and a peripheral device driver. The system also includes a peripheral device adapted to perform at least one function in response to receiving instructions from the host device. The peripheral device driver is adapted to determine when the peripheral device is powered up and in communication with the host device. When the peripheral device is determined to be powered up and in communication with the host device, the peripheral device driver is further adapted to read configuration settings associated with the operating system. The host device further includes an interface adapted to communicate the configuration settings associated with the operating system to the peripheral device for configuring the peripheral device.

In another exemplary embodiment, a printer driver incorporated in a host device is provided. The printer driver comprises a first set of logic functions for determining when a printer is powered up and in communication with the host device. A second set of logic functions of the printer driver includes reading configuration settings associated with an operating system of the host device when the printer is determined to be powered up and in communication with the host device. The printer driver also includes a third set of logic functions for communicating the configuration settings associated with the operating system of the host device to the printer for configuring the printer.

In yet another exemplary embodiment, a method for configuring the settings of a peripheral device is provided. The method includes the step of determining when the peripheral device is powered up and in communication with a host device. The method also includes the step of reading configuration settings associated with an operating system of the host device when the peripheral device is determined to be powered up and in communication with the host device. Also, the method includes communicating the configuration settings associated with the operating system of the host device to the peripheral device for configuring the settings of the peripheral device.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 schematically depicts a block diagram of a system for configuring the settings of a peripheral device according to an embodiment of the present invention.

FIG. 2 schematically depicts a block diagram of the host device shown in FIG. 1 according to an embodiment of the present invention.

FIG. 3 schematically depicts a flow diagram of a method for automatically configuring the settings of a peripheral device according to an embodiment of the present invention.

### DETAILED DESCRIPTION

The present invention is directed to computer networks that include at least one peripheral device for performing specific functions. More particularly, the present invention is directed to systems, methods, and software applications for automatically configuring the settings of one or more peripheral devices with little or no effort required on the part of the user. The embodiments described herein are adapted to retrieve settings that may be stored in the operating system of the host device itself and automatically transmit these settings to the peripheral device. When the peripheral device receives the settings, these settings are entered as the settings for the peripheral device. Therefore, the user is not required to enter the configuration settings into the peripheral device, but a peripheral device driver installed in the host device can automatically control the operations to configure the peripheral device.

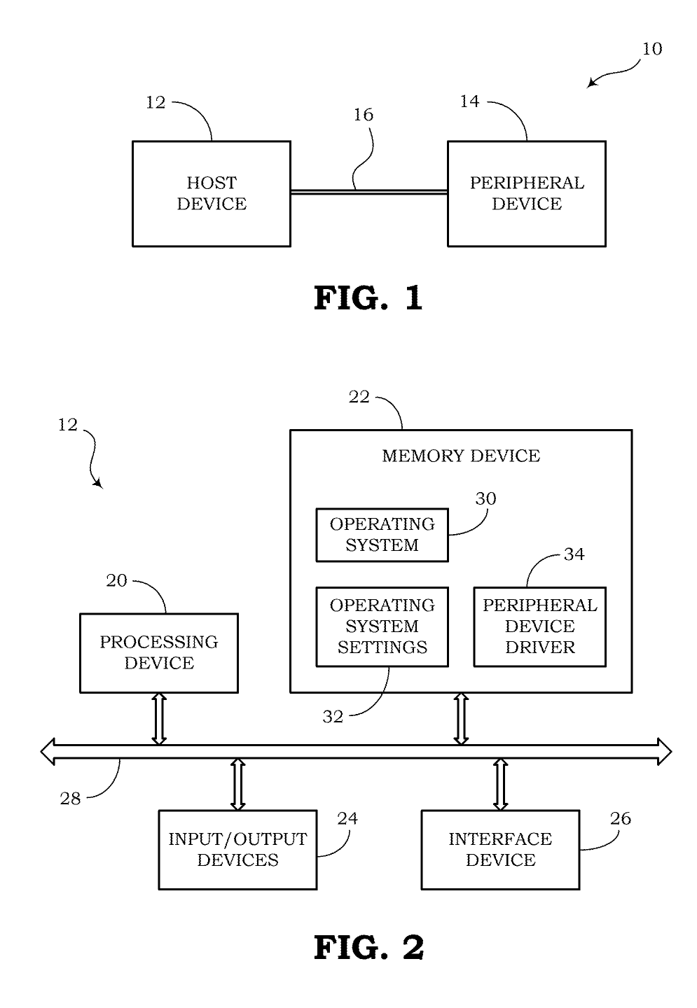

FIG. 1 is a block diagram illustrating an embodiment of a system 10 for configuring a peripheral device. In this embodiment, the system 10 includes a host device 12 and a peripheral device 14. The host device 12 and peripheral device 14 may communicate with each via a wired connection 16 or via a wireless connection. The wired connection 16 may be a Universal Serial Bus (USB) interface or cable having USB connectors at one or both ends. The connection 16 according to various implementations may be a parallel, serial, or network connection, or another type of suitable means for enabling communication between the host device 12 and the peripheral device 14.

According to the teachings of the present disclosure, the host device 12 is configured to detect when the peripheral device 14 is in communication with the host device 12, either by the wired connection 16 or by a wireless communication. Also, the host device 12 determines when the peripheral device 14 is powered up. When these two conditions are met, the host device 12 can begin configuring the settings of the peripheral device 14.

The automatic configuring of the settings is performed by the host device 12 by retrieving settings that are stored with respect to an operating system of the host device 12. The host device 12 then communicates these settings to the peripheral device 14 with instructions for configuring these settings as the respective settings of the peripheral device 14. Since the user will normally want the settings for the peripheral devices, which are connected in the computer system, to be the same as the computer or host device 12, the automatic sharing of the same settings can help to simplify the setup process.

Furthermore, if a peripheral device (e.g., peripheral device 14) is disconnected from the host device 12 and connected to another host device, the second host device can then perform the same automatic setup process by sharing its settings with the peripheral device, provided that the second host device includes the same peripheral device driver that performs the setup process as described below. If the second host device is located in a different environment or has different settings, those settings can be shared with the peripheral device to simplify another setup process or reconfiguration of the peripheral device in the new environment.

Therefore, according to some implementations, the system 10 may be adapted for configuring the settings of a peripheral device. For example, a settings-configuring system (e.g., system 10) may comprise the host device 12, which may include memory for storing at least an operating system and a peripheral device driver. The system 10 may also comprise the peripheral device 14 adapted to perform at least one function in response to receiving instructions from the host device 12. For example, the peripheral device 14 may be adapted to perform printing functions in response to print commands from the host device 12. The peripheral device driver of the host device 12 may be adapted to determine when the peripheral device 14 is powered up and in communication with the host device 12. When the peripheral device 14 is determined to be powered up and in communication with the host device 12, the peripheral device driver is further adapted to read configuration settings associated with the operating system. The host device 12 may further include an interface adapted to communicate the configuration settings associated with the operating system to the peripheral device 14 for configuring the peripheral device 14.

The peripheral device 14 described herein may be a printer or label printer. Configuring the units of measure for a label printer, for instance, may assist with establishing the label sizes. The host device 12 may be a workstation, laptop computer, server, or other computing system.

The configuration settings associated with the operating system may include parameters related to language, date, time, time zone, and a daylight savings setting. Also, the configuration settings associated with the operating system may include geographic region parameters, network environment parameters, and/or unit of measurement parameters.

In some embodiments, the host device 12 may communicate with the peripheral device 14 via the wired connection 16 using at least one USB interface. The peripheral device driver may be adapted to determine when the peripheral device 14 is powered up and in communication with the host device 12 by analyzing a connection event related to the USB interface.

According to some implementations, the system 10 may further include a second host device that also includes memory for storing at least a second operating system and a second peripheral device driver. The peripheral device 14 may be adapted to perform at least one function (e.g., printing functions) in response to receiving instructions from the second host device. The second peripheral device driver may be adapted to determine when the peripheral device 14 is powered up and in communication with the second host device. When the peripheral device 14 is determined to be powered up and in communication with the second host device, the second peripheral device driver is further adapted to read a second set of configuration settings associated with the second operating system and communicate the second set of configuration settings to the peripheral device 14 for reconfiguring the peripheral device 14.

FIG. 2 is a block diagram illustrating an embodiment of the host device 12 shown in FIG. 1. In this embodiment, the host device 12 includes a processing device 20, a memory device 22, input/output devices 24, and an interface device 26, each interconnected via a bus interface 28. The memory device 22, according to some embodiments, may include at least an operating system 30, operating system settings 32, and a peripheral device driver 34. The operating system settings 32 may include various settings regarding the specific geographic region and network environment of the computer system and may also include user preferences.

The processing device 20 may include one or more processors, microprocessors, central processing units, etc. for controlling the operations of the host device 12. The memory device 22 may include volatile and/or non-volatile memory units for storing various types of data, such as software, firmware, tables, settings, etc. The memory device 22 may store the data in removable and/or non-removable memory components.

The input/output devices 24, or other types of user interface components, may include user input devices, such as keys, buttons, switches, touch pads, touch screens, etc. for enabling an end user to enter information into the host device 12. The input/out devices 24 may further include user output devices, such as display screens, light emitting diodes (LEDs), buzzers, and other audible/visual components for communicating information from the host device 12 to the end user.

The interface device 26 may include connectors for enabling connection to cables (e.g., USB connectors) for enabling communication with external devices, such as computer mice, keyboards, and other peripheral devices (e.g., peripheral device 14). In some embodiments, the interface device 26 may include a transmitter, receiver, and/or transceiver for enabling wireless communication with the computer mice, keyboards, or other peripheral devices.

The interface device 26 may be configured, according to the teachings of the present invention, to detect when a proper connection is made with a peripheral device of interest. Also, the interface device 26 may determine, if connection is made, whether or not the peripheral device is powered on. When the two conditions are met, that is, when the peripheral device is properly connected and powered up, the interface device 26 can indicate to the processing device 20 that the conditions have been met.

Generally, the processing device 20 is configured to operate and control the various components of the host device 12 based on instructions and parameters established in the operating system 30. The processing device 20 may occasionally resort to the operating system settings 32 for various settings, such as language, time, date, daylight savings setting, units of measure, user preferences, and other geographic-based information or network environment data. In some embodiments, the operating system 30 and operating system settings 32 may be stored as a single program in the memory device 22.

Regarding the specific teachings of the present invention, the peripheral device driver 34 (e.g., printer driver) is stored in the memory device 22 and is configured to be executed by the processing device 20 to control the operations of the peripheral device 14. However, the peripheral device driver 34 may include instructions that exceed normal printer drivers. For example, in addition to providing regular print operations for a printer, the peripheral device driver 34 also include logic to control the automatic establishment of configuration settings for the peripheral device 14 when it is determined that the peripheral device 14 has been connected to the host device 12 and powered up.

When the processing device 20 utilizes the peripheral device driver 34 to detect the first condition of the peripheral device 14 being properly connected to the interface device 26 (e.g., via the wired connection 16 or via a wireless communication) and the second condition of the peripheral device 14 being powered up, the peripheral device driver 34 includes logic to thereby enable the processing device 20 to share the relevant settings stored in the operating system settings 32 with the peripheral device 14. Also, the settings are shared with the instructions that the settings are to be established as the settings for the peripheral device 14 also. In response to receiving the configuration settings, the peripheral device 14 stores the settings as it normally would if the settings were manually entered by a user under typical setup processes.

In some implementations, the peripheral device driver 34 may be a printer driver with additional logic for sharing configuration settings with a connected printer. The printer driver may be incorporated in the host device 12. The printer driver may include a first set of logic functions for determining when a printer is powered up and in communication with the host device 12. The printer driver may also include a second set of logic functions for reading configuration settings (e.g., operating system settings 32) associated with an operating system (e.g., operating system 30) of the host device 12 when it is determined that the printer is powered up and in communication with the host device 12. The printer driver may further include a third set of logic functions for communicating the configuration settings associated with the operating system of the host device 12 to the printer for configuring the printer.

The printer may be adapted to perform at least one printing function in response to receiving instructions from the host device 12. The host device may be a workstation, laptop computer, server, or other computer system. The configuration settings associated with the operating system may include network environment parameters and/or geographic-related parameters related to language, date, time, time zone, or other parameters.

In some embodiments, the host device 12 may communicate with the printer via a wired connection (e.g., connection 16) using at least one USB interface. The first set of logic functions may be adapted to determine when the printer is powered up and in communication with the host device 12 by analyzing a connection event related to the at least one USB interface.

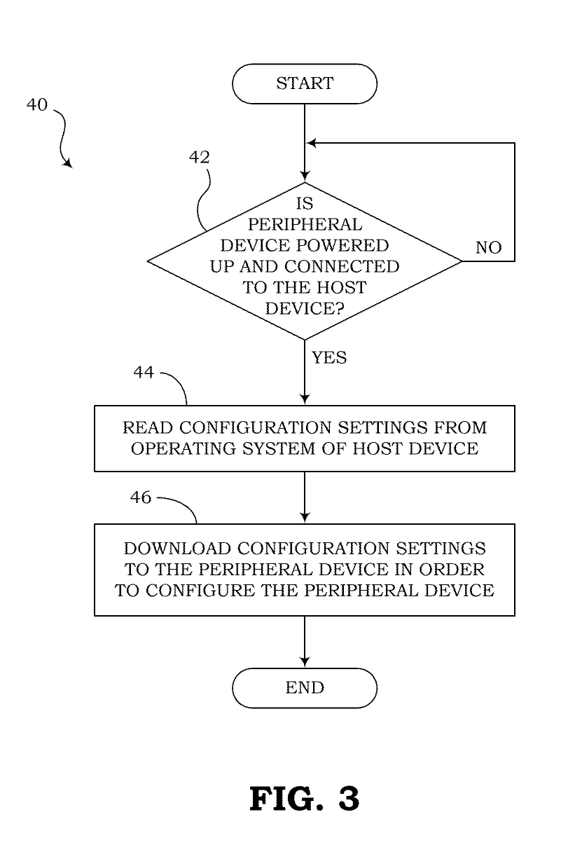

FIG. 3 is a flow diagram illustrating an embodiment of a method 40 for configuring the settings of a peripheral device. According to the illustrated embodiment, the method 40 includes a decision diamond 42 indicating that a step is performed to determine if a peripheral device is powered up and connected to a host device. If the peripheral device is not powered up or is not connected to a host device, the method 40 repeats the decision diamond 42 until both conditions are positive. When it is determined that the peripheral device is powered up and connected to the host device, the method 40 proceeds to block 44.

As indicated in block 44, the configuration settings are read from the operating system of the host device. Block 46 indicates that the configuration settings are then downloaded to the peripheral device in order to configure the peripheral device. In this way, the peripheral device is automatically configured with the settings that already exist in the operating system of the host device.

It should be noted that the method 40 may be performed for any peripheral device and any host device having the specific peripheral device driver 34 described above with respect to FIG. 2. Therefore, if the peripheral device is moved to a different location and connected to another host device, the method 40 may be repeated to reconfigure the configuration settings of the peripheral device using a similar peripheral device driver of the new host device.

The configuration settings may be used by the peripheral device repeatedly as long as the peripheral device remains powered up and connected to the host device. Once the peripheral device is powered off or the connection between the peripheral device and the host device is interrupted, then the method 40 may be repeated to reconfigure the settings of the peripheral device.

If the peripheral device is connected again to the same host device positioned at the same location as before, the configuration settings might normally be the same. However, if the peripheral device is connected to a different host device or the peripheral device and host device are connected again but in a different location, the configuration settings may be different than before. Whether the configuration settings are the same or different, the host device 12 and peripheral device 14 proceed through the method 40 of FIG. 3 to configure or reconfigure the settings upon power up and connection.

Various methods for automatically configuring the settings of a peripheral device may be understood from the teachings of the present disclosure. One method may include a first step of determining when the peripheral device is powered up and in communication with a host device. Another step may include reading configuration settings associated with an operating system of the host device when the peripheral device is determined to be powered up and in communication with the host device. The method may further include the step of communicating the configuration settings associated with the operating system of the host device to the peripheral device for configuring the settings of the peripheral device.

Furthermore, the method may be performed for various systems, such as when the peripheral device is a printer or label printer and when the host device is a workstation or laptop computer. Also, the configuration settings associated with the operating system of the host device may include parameters related to the geographic region of the host device, parameters related to the network environment of the host device, and/or parameters related to a unit of measurement used by the host device.

The step of connecting the host device to the peripheral device may include the use of a USB interface. The step of determining when the peripheral device is powered up and in communication with a host device may further comprise the step of analyzing a connection event related to the USB interface.

In some embodiments, the method may further include a step of determining when the peripheral device is powered up and in communication with a second host device. Additional steps may include reading a second set of configuration settings associated with a second operating system associated with the second host device and then communicating the second set of configuration settings to the peripheral device for reconfiguring the settings of the peripheral device.

To supplement the present disclosure, this application incorporates entirely by reference the following commonly assigned patents, patent application publications, and patent applications:

U.S. Pat. Nos. 6,832,725; 7,128,266; 7,159,783; 7,413,127; 7,726,575; 8,294,969; 8,317,105; 8,322,622; 8,366,005; 8,371,507; 8,376,233; 8,381,979; 8,390,909; 8,408,464; 8,408,468; 8,408,469; 8,424,768; 8,448,863; 8,457,013; 8,459,557; 8,469,272; 8,474,712; 8,479,992; 8,490,877; 8,517,271; 8,523,076; 8,528,818; 8,544,737; 8,548,242; 8,548,420; 8,550,335; 8,550,354; 8,550,357; 8,556,174; 8,556,176; 8,556,177; 8,559,767; 8,599,957; 8,561,895; 8,561,903; 8,561,905; 8,565,107; 8,571,307; 8,579,200; 8,583,924; 8,584,945; 8,587,595; 8,587,697; 8,588,869; 8,590,789; 8,596,539; 8,596,542; 8,596,543; 8,599,271; 8,599,957; 8,600,158; 8,600,167; 8,602,309; 8,608,053; 8,608,071; 8,611,309; 8,615,487; 8,616,454; 8,621,123; 8,622,303; 8,628,013; 8,628,015; 8,628,016; 8,629,926; 8,630,491; 8,635,309; 8,636,200; 8,636,212; 8,636,215; 8,636,224; 8,638,806; 8,640,958; 8,640,960; 8,643,717; 8,646,692; 8,646,694; 8,657,200; 8,659,397; 8,668,149; 8,678,285; 8,678,286; 8,682,077; 8,687,282; 8,692,927; 8,695,880; 8,698,949; 8,717,494; 8,717,494; 8,720,783; 8,723,804; 8,723,904; 8,727,223; 8,740,082; 8,740,085; 8,746,563; 8,750,445; 8,752,766; 8,756,059; 8,757,495; 8,760,563; 8,763,909; 8,777,108; 8,777,109; 8,779,898; 8,781,520; 8,783,573; 8,789,757; 8,789,758; 8,789,759; 8,794,520; 8,794,522; 8,794,525; 8,794,526; 8,798,367; 8,807,431; 8,807,432; 8,820,630; 8,822,848; 8,824,692; 8,824,696; 8,842,849; 8,844,822; 8,844,823; 8,849,019; 8,851,383; 8,854,633; 8,866,963; 8,868,421; 8,868,519; 8,868,802; 8,868,803; 8,870,074; 8,879,639; 8,880,426; 8,881,983; 8,881,987; 8,903,172; 8,908,995; 8,910,870; 8,910,875; 8,914,290; 8,914,788; 8,915,439; 8,915,444; 8,916,789; 8,918,250; 8,918,564; 8,925,818; 8,939,374; 8,942,480; 8,944,313; 8,944,327; 8,944,332; 8,950,678; 8,967,468; 8,971,346; 8,976,030; 8,976,368; 8,978,981; 8,978,983; 8,978,984; 8,985,456; 8,985,457; 8,985,459; 8,985,461; 8,988,578; 8,988,590; 8,991,704; 8,996,194; 8,996,384; 9,002,641; 9,007,368; 9,010,641; 9,015,513; 9,016,576; 9,022,288; 9,030,964; 9,033,240; 9,033,242; 9,036,054; 9,037,344; 9,038,911; 9,038,915; 9,047,098; 9,047,359; 9,047,420; 9,047,525; 9,047,531; 9,053,055; 9,053,378; 9,053,380; 9,058,526; 9,064,165; 9,064,165; 9,064,167; 9,064,168; 9,064,254; 9,066,032; 9,070,032; 9,076,459; 9,079,423; 9,080,856; 9,082,023; 9,082,031; 9,084,032; 9,087,250; 9,092,681; 9,092,682; 9,092,683; 9,093,141; 9,098,763; 9,104,929; 9,104,934; 9,107,484; 9,111,159; 9,111,166; 9,135,483; 9,137,009; 9,141,839; 9,147,096; 9,148,474; 9,158,000; 9,158,340; 9,158,953; 9,159,059; 9,165,174; 9,171,543; 9,183,425; 9,189,669; 9,195,844; 9,202,458; 9,208,366; 9,208,367; 9,219,836; 9,224,024; 9,224,027; 9,230,140; 9,235,553; 9,239,950; 9,245,492; 9,248,640; 9,250,652; 9,250,712; 9,251,411; 9,258,033; 9,262,633; 9,262,660; 9,262,662; 9,269,036; 9,270,782; 9,274,812; 9,275,388; 9,277,668; 9,280,693; 9,286,496; 9,298,964; 9,301,427; 9,313,377; 9,317,037; 9,319,548; 9,342,723; 9,361,882; 9,365,381; 9,373,018; 9,375,945; 9,378,403; 9,383,848; 9,384,374; 9,390,304; 9,390,596; 9,411,386; 9,412,242; 9,418,269; 9,418,270; 9,465,967; 9,423,318; 9,424,454; 9,436,860; 9,443,123; 9,443,222; 9,454,689; 9,464,885; 9,465,967; 9,478,983; 9,481,186; 9,487,113; 9,488,986; 9,489,782; 9,490,540; 9,491,729; 9,497,092; 9,507,974; 9,519,814; 9,521,331; 9,530,038; 9,572,901; 9,558,386; 9,606,581; 9,646,189; 9,646,191; 9,652,648; 9,652,653; 9,656,487; 9,659,198; 9,680,282; 9,697,401; 9,701,140; U.S. Design Pat. No. D702,237; U.S. Design Pat. No. D716,285; U.S. Design Pat. No. D723,560; U.S. Design Pat. No. D730,357; U.S. Design Pat. No. D730,901; U.S. Design Pat. No. D730,902; U.S. Design Pat. No. D734,339; U.S. Design Pat. No. D737,321; U.S. Design Pat. No. D754,205; U.S. Design Pat. No. D754,206; U.S. Design Pat. No. D757,009; U.S. Design Pat. No. D760,719; U.S. Design Pat. No. D762,604; U.S. Design Pat. No. D766,244; U.S. Design Pat. No. D777,166; U.S. Design Pat. No. D771,631; U.S. Design Pat. No. D783,601; U.S. Design Pat. No. D785,617; U.S. Design Pat. No. D785,636; U.S. Design Pat. No. D790,505; U.S. Design Pat. No. D790,546; International Publication No. 2013/163789; U.S. Patent Application Publication No. 2008/0185432; U.S. Patent Application Publication No. 2009/0134221; U.S. Patent Application Publication No. 2010/0177080; U.S. Patent Application Publication No. 2010/0177076; U.S. Patent Application Publication No. 2010/0177707; U.S. Patent Application Publication No. 2010/0177749; U.S. Patent Application Publication No. 2010/0265880; U.S. Patent Application Publication No. 2011/0202554; U.S. Patent Application Publication No. 2012/0111946; U.S. Patent Application Publication No. 2012/0168511; U.S. Patent Application Publication No. 2012/0168512; U.S. Patent Application Publication No. 2012/0193423; U.S. Patent Application Publication No. 2012/0194692; U.S. Patent Application Publication No. 2012/0203647; U.S. Patent Application Publication No. 2012/0223141; U.S. Patent Application Publication No. 2012/0228382; U.S. Patent Application Publication No. 2012/0248188; U.S. Patent Application Publication No. 2013/0043312; U.S. Patent Application Publication No. 2013/0082104; U.S. Patent Application Publication No. 2013/0175341; U.S. Patent Application Publication No. 2013/0175343; U.S. Patent Application Publication No. 2013/0257744; U.S. Patent Application Publication No. 2013/0257759; U.S. Patent Application Publication No. 2013/0270346; U.S. Patent Application Publication No. 2013/0292475; U.S. Patent Application Publication No. 2013/0292477; U.S. Patent Application Publication No. 2013/0293539; U.S. Patent Application Publication No. 2013/0293540; U.S. Patent Application Publication No. 2013/0306728; U.S. Patent Application Publication No. 2013/0306731; U.S. Patent Application Publication No. 2013/0307964; U.S. Patent Application Publication No. 2013/0308625; U.S. Patent Application Publication No. 2013/0313324; U.S. Patent Application Publication No. 2013/0332996; U.S. Patent Application Publication No. 2014/0001267; U.S. Patent Application Publication No. 2014/0025584; U.S. Patent Application Publication No. 2014/0034734; U.S. Patent Application Publication No. 2014/0036848; U.S. Patent Application Publication No. 2014/0039693; U.S. Patent Application Publication No. 2014/0049120; U.S. Patent Application Publication No. 2014/0049635; U.S. Patent Application Publication No. 2014/0061306; U.S. Patent Application Publication No. 2014/0063289; U.S. Patent Application Publication No. 2014/0066136; U.S. Patent Application Publication No. 2014/0067692; U.S. Patent Application Publication No. 2014/0070005; U.S. Patent Application Publication No. 2014/0071840; U.S. Patent Application Publication No. 2014/0074746; U.S. Patent Application Publication No. 2014/0076974; U.S. Patent Application Publication No. 2014/0097249; U.S. Patent Application Publication No. 2014/0098792; U.S. Patent Application Publication No. 2014/0100813; U.S. Patent Application Publication No. 2014/0103115; U.S. Patent Application Publication No. 2014/0104413; U.S. Patent Application Publication No. 2014/0104414; U.S. Patent Application Publication No. 2014/0104416; U.S. Patent Application Publication No. 2014/0106725; U.S. Patent Application Publication No. 2014/0108010; U.S. Patent Application Publication No. 2014/0108402; U.S. Patent Application Publication No. 2014/0110485; U.S. Patent Application Publication No. 2014/0125853; U.S. Patent Application Publication No. 2014/0125999; U.S. Patent Application Publication No. 2014/0129378; U.S. Patent Application Publication No. 2014/0131443; U.S. Patent Application Publication No. 2014/0133379; U.S. Patent Application Publication No. 2014/0136208; U.S. Patent Application Publication No. 2014/0140585; U.S. Patent Application Publication No. 2014/0152882; U.S. Patent Application Publication No. 2014/0158770; U.S. Patent Application Publication No. 2014/0159869; U.S. Patent Application Publication No. 2014/0166759; U.S. Patent Application Publication No. 2014/0168787; U.S. Patent Application Publication No. 2014/0175165; U.S. Patent Application Publication No. 2014/0191684; U.S. Patent Application Publication No. 2014/0191913; U.S. Patent Application Publication No. 2014/0197304; U.S. Patent Application Publication No. 2014/0214631; U.S. Patent Application Publication No. 2014/0217166; U.S. Patent Application Publication No. 2014/0231500; U.S. Patent Application Publication No. 2014/0247315; U.S. Patent Application Publication No. 2014/0263493; U.S. Patent Application Publication No. 2014/0263645; U.S. Patent Application Publication No. 2014/0270196; U.S. Patent Application Publication No. 2014/0270229; U.S. Patent Application Publication No. 2014/0278387; U.S. Patent Application Publication No. 2014/0288933; U.S. Patent Application Publication No. 2014/0297058; U.S. Patent Application Publication No. 2014/0299665; U.S. Patent Application Publication No. 2014/0332590; U.S. Patent Application Publication No. 2014/0351317; U.S. Patent Application Publication No. 2014/0362184; U.S. Patent Application Publication No. 2014/0363015; U.S. Patent Application Publication No. 2014/0369511; U.S. Patent Application Publication No. 2014/0374483; U.S. Patent Application Publication No. 2014/0374485; U.S. Patent Application Publication No. 2015/0001301; U.S. Patent Application Publication No. 2015/0001304; U.S. Patent Application Publication No. 2015/0009338; U.S. Patent Application Publication No. 2015/0014416; U.S. Patent Application Publication No. 2015/0021397; U.S. Patent Application Publication No. 2015/0028104; U.S. Patent Application Publication No. 2015/0029002; U.S. Patent Application Publication No. 2015/0032709; U.S. Patent Application Publication No. 2015/0039309; U.S. Patent Application Publication No. 2015/0039878; U.S. Patent Application Publication No. 2015/0040378; U.S. Patent Application Publication No. 2015/0049347; U.S. Patent Application Publication No. 2015/0051992; U.S. Patent Application Publication No. 2015/0053769; U.S. Patent Application Publication No. 2015/0062366; U.S. Patent Application Publication No. 2015/0063215; U.S. Patent Application Publication No. 2015/0088522; U.S. Patent Application Publication No. 2015/0096872; U.S. Patent Application Publication No. 2015/0100196; U.S. Patent Application Publication No. 2015/0102109; U.S. Patent Application Publication No. 2015/0115035; U.S. Patent Application Publication No. 2015/0127791; U.S. Patent Application Publication No. 2015/0128116; U.S. Patent Application Publication No. 2015/0133047; U.S. Patent Application Publication No. 2015/0134470; U.S. Patent Application Publication No. 2015/0136851; U.S. Patent Application Publication No. 2015/0142492; U.S. Patent Application Publication No. 2015/0144692; U.S. Patent Application Publication No. 2015/0144698; U.S. Patent Application Publication No. 2015/0149946; U.S. Patent Application Publication No. 2015/0161429; U.S. Patent Application Publication No. 2015/0178523; U.S. Patent Application Publication No. 2015/0178537; U.S. Patent Application Publication No. 2015/0178685; U.S. Patent Application Publication No. 2015/0181109; U.S. Patent Application Publication No. 2015/0199957; U.S. Patent Application Publication No. 2015/0210199; U.S. Patent Application Publication No. 2015/0212565; U.S. Patent Application Publication No. 2015/0213647; U.S. Patent Application Publication No. 2015/0220753; U.S. Patent Application Publication No. 2015/0220901; U.S. Patent Application Publication No. 2015/0227189; U.S. Patent Application Publication No. 2015/0236984; U.S. Patent Application Publication No. 2015/0239348; U.S. Patent Application Publication No. 2015/0242658; U.S. Patent Application Publication No. 2015/0248572; U.S. Patent Application Publication No. 2015/0254485; U.S. Patent Application Publication No. 2015/0261643; U.S. Patent Application Publication No. 2015/0264624; U.S. Patent Application Publication No. 2015/0268971; U.S. Patent Application Publication No. 2015/0269402; U.S. Patent Application Publication No. 2015/0288689; U.S. Patent Application Publication No. 2015/0288896; U.S. Patent Application Publication No. 2015/0310243; U.S. Patent Application Publication No. 2015/0310244; U.S. Patent Application Publication No. 2015/0310389; U.S. Patent Application Publication No. 2015/0312780; U.S. Patent Application Publication No. 2015/0327012; U.S. Patent Application Publication No. 2016/0014251; U.S. Patent Application Publication No. 2016/0025697; U.S. Patent Application Publication No. 2016/0026838; U.S. Patent Application Publication No. 2016/0026839; U.S. Patent Application Publication No. 2016/0040982; U.S. Patent Application Publication No. 2016/0042241; U.S. Patent Application Publication No. 2016/0057230; U.S. Patent Application Publication No. 2016/0062473; U.S. Patent Application Publication No. 2016/0070944; U.S. Patent Application Publication No. 2016/0092805; U.S. Patent Application Publication No. 2016/0101936; U.S. Patent Application Publication No. 2016/0104019; U.S. Patent Application Publication No. 2016/0104274; U.S. Patent Application Publication No. 2016/0109219; U.S. Patent Application Publication No. 2016/0109220; U.S. Patent Application Publication No. 2016/0109224; U.S. Patent Application Publication No. 2016/0112631; U.S. Patent Application Publication No. 2016/0112643; U.S. Patent Application Publication No. 2016/0117627; U.S. Patent Application Publication No. 2016/0124516; U.S. Patent Application Publication No. 2016/0125217; U.S. Patent Application Publication No. 2016/0125342; U.S. Patent Application Publication No. 2016/0125873; U.S. Patent Application Publication No. 2016/0133253; U.S. Patent Application Publication No. 2016/0171597; U.S. Patent Application Publication No. 2016/0171666; U.S. Patent Application Publication No. 2016/0171720; U.S. Patent Application Publication No. 2016/0171775; U.S. Patent Application Publication No. 2016/0171777; U.S. Patent Application Publication No. 2016/0174674; U.S. Patent Application Publication No. 2016/0178479; U.S. Patent Application Publication No. 2016/0178685; U.S. Patent Application Publication No. 2016/0178707; U.S. Patent Application Publication No. 2016/0179132; U.S. Patent Application Publication No. 2016/0179143; U.S. Patent Application Publication No. 2016/0179368; U.S. Patent Application Publication No. 2016/0179378; U.S. Patent Application Publication No. 2016/0180130; U.S. Patent Application Publication No. 2016/0180133; U.S. Patent Application Publication No. 2016/0180136; U.S. Patent Application Publication No. 2016/0180594; U.S. Patent Application Publication No. 2016/0180663; U.S. Patent Application Publication No. 2016/0180678; U.S. Patent Application Publication No. 2016/0180713; U.S. Patent Application Publication No. 2016/0185136; U.S. Patent Application Publication No. 2016/0185291; U.S. Patent Application Publication No. 2016/0186926; U.S. Patent Application Publication No. 2016/0188861; U.S. Patent Application Publication No. 2016/0188939; U.S. Patent Application Publication No. 2016/0188940; U.S. Patent Application Publication No. 2016/0188941; U.S. Patent Application Publication No. 2016/0188942; U.S. Patent Application Publication No. 2016/0188943; U.S. Patent Application Publication No. 2016/0188944; U.S. Patent Application Publication No. 2016/0189076; U.S. Patent Application Publication No. 2016/0189087; U.S. Patent Application Publication No. 2016/0189088; U.S. Patent Application Publication No. 2016/0189092; U.S. Patent Application Publication No. 2016/0189284; U.S. Patent Application Publication No. 2016/0189288; U.S. Patent Application Publication No. 2016/0189366; U.S. Patent Application Publication No. 2016/0189443; U.S. Patent Application Publication No. 2016/0189447; U.S. Patent Application Publication No. 2016/0189489; U.S. Patent Application Publication No. 2016/0192051; U.S. Patent Application Publication No. 2016/0202951; U.S. Patent Application Publication No. 2016/0202958; U.S. Patent Application Publication No. 2016/0202959; U.S. Patent Application Publication No. 2016/0203021; U.S. Patent Application Publication No. 2016/0203429; U.S. Patent Application Publication No. 2016/0203797; U.S. Patent Application Publication No. 2016/0203820; U.S. Patent Application Publication No. 2016/0204623; U.S. Patent Application Publication No. 2016/0204636; U.S. Patent Application Publication No. 2016/0204638; U.S. Patent Application Publication No. 2016/0227912; U.S. Patent Application Publication No. 2016/0232891; U.S. Patent Application Publication No. 2016/0292477; U.S. Patent Application Publication No. 2016/0294779; U.S. Patent Application Publication No. 2016/0306769; U.S. Patent Application Publication No. 2016/0314276; U.S. Patent Application Publication No. 2016/0314294; U.S. Patent Application Publication No. 2016/0316190; U.S. Patent Application Publication No. 2016/0323310; U.S. Patent Application Publication No. 2016/0325677; U.S. Patent Application Publication No. 2016/0327614; U.S. Patent Application Publication No. 2016/0327930; U.S. Patent Application Publication No. 2016/0328762; U.S. Patent Application Publication No. 2016/0330218; U.S. Patent Application Publication No. 2016/0343163; U.S. Patent Application Publication No. 2016/0343176; U.S. Patent Application Publication No. 2016/0364914; U.S. Patent Application Publication No. 2016/0370220; U.S. Patent Application Publication No. 2016/0372282; U.S. Patent Application Publication No. 2016/0373847; U.S. Patent Application Publication No. 2016/0377414; U.S. Patent Application Publication No. 2016/0377417; U.S. Patent Application Publication No. 2017/0010141; U.S. Patent Application Publication No. 2017/0010328; U.S. Patent Application Publication No. 2017/0010780; U.S. Patent Application Publication No. 2017/0016714; U.S. Patent Application Publication No. 2017/0018094; U.S. Patent Application Publication No. 2017/0046603; U.S. Patent Application Publication No. 2017/0047864; U.S. Patent Application Publication No. 2017/0053146; U.S. Patent Application Publication No. 2017/0053147; U.S. Patent Application Publication No. 2017/0053647; U.S. Patent Application Publication No. 2017/0055606; U.S. Patent Application Publication No. 2017/0060316; U.S. Patent Application Publication No. 2017/0061961; U.S. Patent Application Publication No. 2017/0064634; U.S. Patent Application Publication No. 2017/0083730; U.S. Patent Application Publication No. 2017/0091502; U.S. Patent Application Publication No. 2017/0091706; U.S. Patent Application Publication No. 2017/0091741; U.S. Patent Application Publication No. 2017/0091904; U.S. Patent Application Publication No. 2017/0092908; U.S. Patent Application Publication No. 2017/0094238; U.S. Patent Application Publication No. 2017/0098947; U.S. Patent Application Publication No. 2017/0100949; U.S. Patent Application Publication No. 2017/0108838; U.S. Patent Application Publication No. 2017/0108895; U.S. Patent Application Publication No. 2017/0118355; U.S. Patent Application Publication No. 2017/0123598; U.S. Patent Application Publication No. 2017/0124369; U.S. Patent Application Publication No. 2017/0124396; U.S. Patent Application Publication No. 2017/0124687; U.S. Patent Application Publication No. 2017/0126873; U.S. Patent Application Publication No. 2017/0126904; U.S. Patent Application Publication No. 2017/0139012; U.S. Patent Application Publication No. 2017/0140329; U.S. Patent Application Publication No. 2017/0140731; U.S. Patent Application Publication No. 2017/0147847; U.S. Patent Application Publication No. 2017/0150124; U.S. Patent Application Publication No. 2017/0169198; U.S. Patent Application Publication No. 2017/0171035; U.S. Patent Application Publication No. 2017/0171703; U.S. Patent Application Publication No. 2017/0171803; U.S. Patent Application Publication No. 2017/0180359; U.S. Patent Application Publication No. 2017/0180577; U.S. Patent Application Publication No. 2017/0181299; U.S. Patent Application Publication No. 2017/0190192; U.S. Patent Application Publication No. 2017/0193432; U.S. Patent Application Publication No. 2017/0193461; U.S. Patent Application Publication No. 2017/0193727; U.S. Patent Application Publication No. 2017/0199266; U.S. Patent Application Publication No. 2017/0200108; and U.S. Patent Application Publication No. 2017/0200275.

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A system for configuring the settings of a peripheral device, the system comprising:
a host device including memory for storing at least an operating system and a peripheral device driver; and
a peripheral device adapted to perform at least one function in response to receiving instructions from the host device;
wherein the peripheral device driver is adapted to determine when the peripheral device is powered up and in communication with the host device;
wherein, when the peripheral device is determined to be powered up and in communication with the host device, the peripheral device driver is further adapted to read configuration settings associated with the operating system; and
wherein the host device further includes an interface adapted to communicate the configuration settings associated with the operating system to the peripheral device for configuring the peripheral device.

2. The system of claim 1, wherein the peripheral device is a printer or label printer.

3. The system of claim 1, wherein the host device is a workstation or laptop computer.

4. The system of claim 1, wherein the configuration settings associated with the operating system include parameters related to language, date, time, time zone, and a daylight savings setting.

5. The system of claim 1, wherein the configuration settings associated with the operating system include geographic region parameters, network environment parameters, and/or unit of measurement parameters.

6. The system of claim 1, wherein the host device communicates with the peripheral device via a wired connection using a Universal Serial Bus (USB) interface.

7. The system of claim 6, wherein the peripheral device driver determines when the peripheral device is powered up and in communication with the host device by analyzing a connection event related to the USB interface.

8. The system of claim 1, further comprising a second host device including memory for storing at least a second operating system and a second peripheral device driver, wherein the peripheral device is adapted to perform at least one function in response to receiving instructions from the second host device, wherein the second peripheral device driver is adapted to determine when the peripheral device is powered up and in communication with the second host device, wherein, when the peripheral device is determined to be powered up and in communication with the second host device, the second peripheral device driver is further adapted to read a second set of configuration settings associated with the second operating system and communicate the second set of configuration settings to the peripheral device for reconfiguring the peripheral device.

9. A printer driver incorporated in a host device, the printer driver comprising:
a first set of logic functions for determining when a printer is powered up and in communication with the host device;
a second set of logic functions for reading configuration settings associated with an operating system of the host device when the printer is determined to be powered up and in communication with the host device;
a third set of logic functions for communicating the configuration settings associated with the operating system of the host device to the printer for configuring the printer.

10. The printer driver of claim 9, wherein the printer is adapted to perform at least one printing function in response to receiving instructions from the host device.

11. The printer driver of claim 9, wherein the host device is a workstation or laptop computer.

12. The printer driver of claim 9, wherein the configuration settings associated with the operating system include network environment parameters and/or geographic-related parameters of language, date, time, and time zone.

13. The printer driver of claim 9, wherein the host device communicates with the printer via a wired connection using at least one Universal Serial Bus (USB) interface.

14. The printer driver of claim 13, wherein the first set of logic functions determines when the printer is powered up and in communication with the host device by analyzing a connection event related to the at least one USB interface.

15. A method for configuring the settings of a peripheral device, the method comprising the steps of:
determining when the peripheral device is powered up and in communication with a host device;
reading configuration settings associated with an operating system of the host device when the peripheral device is determined to be powered up and in communication with the host device; and
communicating the configuration settings associated with the operating system of the host device to the peripheral device for configuring the settings of the peripheral device.

16. The method of claim 15, wherein the peripheral device is a printer or label printer and the host device is a workstation or laptop computer.

17. The method of claim 15, wherein the configuration settings associated with the operating system of the host device include parameters related to the geographic region of the host device, parameters related to the network environment of the host device, and/or parameters related to a unit of measurement used by the host device.

18. The method of claim 15, further comprising the step of connecting the host device to the peripheral device using a Universal Serial Bus (USB) interface.

19. The method of claim 18, wherein the step of determining when the peripheral device is powered up and in communication with a host device further comprises analyzing a connection event related to the USB interface.

20. The method of claim 15, further comprising the steps of:
determining when the peripheral device is powered up and in communication with a second host device;
reading a second set of configuration settings associated with a second operating system associated with the second host device; and
communicating the second set of configuration settings to the peripheral device for reconfiguring the settings of the peripheral device.
